(19) United States
(12) Patent Application Publication
(10) Pub. No.: US 2017/0070495 A1
(43) Pub. Date: Mar. 9, 2017

(54) METHOD TO SECURE FILE ORIGINATION, ACCESS AND UPDATES

(71) Applicants: Michael A. Cherry, Falls Church, VA (US); Mark Henry Switzer, Toronto (CA); Manfred Schenk, Los Angeles, CA (US)

(72) Inventors: Michael A. Cherry, Falls Church, VA (US); Mark Henry Switzer, Toronto (CA); Manfred Schenk, Los Angeles, CA (US)

(21) Appl. No.: 14/848,678

(22) Filed: Sep. 9, 2015

(51) Int. Cl. H04L 29/06; G06F 21/62

(52) U.S. Cl. CPC H04L 63/08; H04L 63/0428; G06F 21/62

(57) ABSTRACT

A method to secure file origination, access and updates between a sender and a receiver is provided. The method includes generating a transmit payload to transmit to the receiver, generating an authentication data structure to transmit to the receiver, generating a permissions credential to transmit to the receiver, creating a scrambled message by combining and transforming the transmit payload, the authentication data structure, and the permissions credential, using a pre-determined scheme, transmitting the scrambled message to the receiver, receiving the scrambled message, applying the pre-determined scheme to recover a received payload, a received authentication data structure, and a received permissions credential, from the scrambled message, evaluating the received authentication data structure, and if authentication fails, ignoring the received payload, evaluating the received permissions credential, and if the received permissions credentials are insufficient, ignoring the received payload, and performing steps (a.)-(k.) for subsequent communications between the sender and the receiver.

### TECHNICAL FIELD

The present disclosure generally relates to securing electronic data storage as well as internet based transactions.

### DESCRIPTION OF THE RELATED ART

Rather than allowing a hijacker or a hijacked computer to access data, a “real time” data center challenge can be made, to determine the authenticity of the requester including their biometrics, geolocation and permission to access each requested document or any item thereof. The explosive growth of the internet has given rise to internet based transactions, like electronic communication (e.g. email), banking services, shopping, and even social media. This increase in internet based activity has also given rise to security concerns. Nefarious individuals are constantly evolving and facilitating sophisticated attacks to violate the trust and security of internet based transactions, and their underlying computer systems. Every type of transaction activity that occurs on the internet is or has been subject to some sort of attack by cyber-attackers. Whether it is identify theft, electronic funds transfer fraud, or violations of privacy, the security and convenience of internet based transactions are constantly being threatened.

Security of internet based transactions and the underlying computer systems that support them generally involve security features like: confidentiality, integrity, availability, non-repudiation, and authenticity. Confidentiality is generally seen as analogous to privacy. Confidentiality reiterates the need to protect information from being disclosed to unauthorized parties. The idea of preventing sensitive information from reaching the wrong people, while making sure that the right people can in fact get it, is fundamental to industries like banking, and healthcare. For example, access to a website with bank records may be granted to a certain individual, while being restricted to everyone else. One common method of ensuring confidentiality includes data encryption. Encryption ensures that only the right people (people who know the key) can read the information. A common example is SSL/TLS, a security protocol for communications over the internet that has been used in conjunction with a large number of internet protocols to ensure security.

The underpinning of confidentiality is authenticity and authentication methods like the use of user IDs and passwords that uniquely identify a user's access. Essentially, it is the principle that a user for example, who claims to be someone, is in fact that particular individual.

Integrity involves maintaining the consistency, accuracy, and trustworthiness of information and preventing modification by unauthorized parties. Information is valuable, only if it is correct. An incorrectly high bank balance for example, can be used as a basis to disburse funds that normally would not have been allowed. Commonly used methods to protect data integrity include hashing, digital signatures, and even encryption.

Availability of information refers to ensuring that authorized parties are able to access the information when needed. Denying access to information is a very common attack. Internet websites are constantly being attacked by Denial of Service (DOS) or Distributed DOS (DDOS) attacks. The primary purpose of such an attack is to deny legitimate access to the victimized web site.

Cyber-attackers are constantly seeking to thwart the confidentiality, integrity, or availability of a particular internet transaction. Cyber-attackers usually have an arsenal of attack vectors through which they seek to achieve their goals. An attack vector is a means by which a criminal can gain access to a computer, network, or obtain visibility into a purportedly secure internet transaction, in order to obtain information, deliver a malicious payload, or otherwise seek to compromise the confidentiality, integrity, or availability.

For example, a man-in-the-middle attack is an attack where the attacker secretly relays and possibly alters the communication between two parties who believe they are directly communicating with each other. SQL injection is a type of attack that works by manipulating the database queries that a web application sends. An application can be vulnerable if it does not sanitize user input properly or use untrusted parameter values in database queries without validation. Weak authentication (e.g. weak password complexity requirements) can allow a hacker to guess passwords using a brute force attack and thereby obtain access to the target system.

While there are many different techniques that can help bolster the confidentiality, integrity, and availability of an internet based transaction, and its underlying computer system, almost all techniques have flaws, are expensive to implement, or become easily outdated in the face of evolving threats. Therefore, there is a need for a method to secure file origination, access and updates.

### SUMMARY OF THE DISCLOSED EMBODIMENTS

In one aspect, a system and method for securing file origination, access and updates is provided. The system includes a client device, biometric device, server, database, and computer network. In an embodiment, a sender uses a client device to generate a payload to be transmitted to a receiver. In another embodiment, an authentication data structure and permissions credential is generated.

In one aspect, a method for securing file origination, access and updates is provided. The method includes generating a transmit payload, generating an authentication data structure, generating a permissions credential, creating a scrambled message, transmitting the scrambled message, receiving the scrambled message, deciphering the scrambled message, evaluating the received authentication, and evaluating the received permissions.

The method further includes using a pre-determined scheme to generate an obfuscated scrambled message. In one embodiment, the scramble message includes logically combined portions of the transmit payload, authentication data structure, and permissions credential.

The method further includes the steps of deciphering the scrambled message. In one embodiment, the scramble message is deciphered using the pre-determined scheme.

The method further includes evaluating the received authentication, and evaluating the received permissions. If the evaluation is successful, the scrambled message is processed. If the evaluation is unsuccessful, the scrambled message is unsuccessful.

The method further includes storing the scrambled message. In one embodiment, the scramble message is stored in its entirety on a database for secure storage.

### BRIEF DESCRIPTION OF THE DRAWINGS

FIG. 1 illustrates a schematic diagram of a system to secure file origination, access and updates.

FIG. 2 illustrates a schematic flow diagram of a method to secure file origination, access and updates.

FIG. 3 illustrates a schematic diagram of a system to secure file origination, access and updates.

FIG. 4 illustrates a schematic diagram of a system to secure file origination, access and updates.

FIG. 5 illustrates a schematic diagram of a system to secure file origination, access and updates.

FIG. 6 illustrates a schematic diagram of a system to secure file origination, access and updates.

### DETAILED DESCRIPTION OF THE VARIOUS EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language—interpreted, compiled, or otherwise. These languages may include, but are not limited to, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

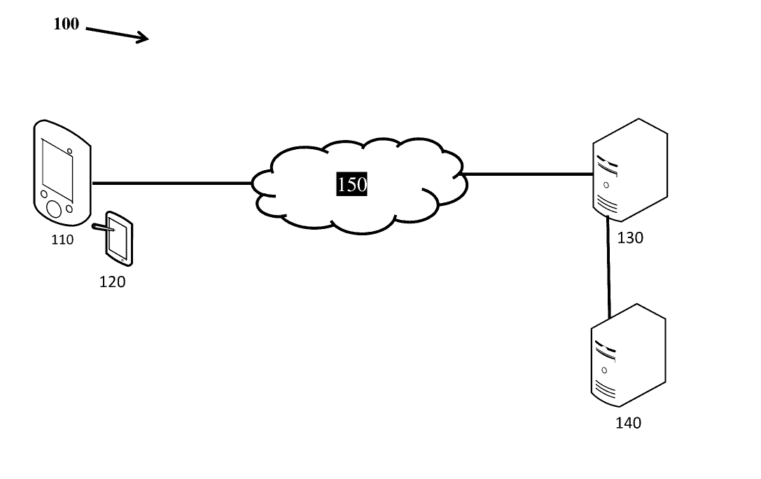

Referring now to FIG. 1, there is shown a schematic drawing of a system and method to secure file origination, access and updates, generally indicated at 100. In at least one embodiment of present invention, the system 100 comprises client device 110, biometric device 120, server 130, database 140, and computer network 150.

The client device 110 may be configured to transmit information to and generally interact with a web service and/or application programming interface infrastructure housed on server 130 over computer network 150. The client device 110 may include a web browser; mobile application, socket or tunnel, or other network connected software such that communication with the web services infrastructure on server 130 is possible over the computer network 150.

The client device 110 includes one or more computers, smartphones, tablets, wearable technology, computing devices, or systems of a type well known in the art, such as a mainframe computer, workstation, personal computer, laptop computer, hand-held computer, cellular telephone, or personal digital assistant. The client device 110 comprises such software, hardware, and componentry as would occur to one of skill in the art, such as, for example, one or more microprocessors, memory systems, input/output devices, device controllers, and the like. The client device 110 also comprises one or more data entry means (not shown in FIG. 1) operable by users of the client device 110 for data entry, such as, for example, voice or audio control, a pointing device (such as a mouse), keyboard, touchscreen, microphone, voice recognition, and/or other data entry means known in the art. The client device 110 also comprises a display means (not shown in FIG. 1) which may comprise various types of known displays such as liquid crystal diode displays, light emitting diode display, and the like upon which information may be display in a manner perceptible to the user.

The authentication device 120 includes one or more devices or systems of a type well known in the art, such as cellphone, Global Positioning System (GPS) transceiver, fingerprint scanner, iris reader, retina scanner, camera, microphone, keyboard, key fob, or token. The authentication device 120 comprises such software, hardware, and componentry as would occur to one of skill in the art, to operably perform the functions allocated to the authentication device 120 in accordance with the present disclosure. It will be appreciated that authentication device 120 may be integrated into client device 110, or remain as a standalone device.

The database 140 is configured to store information generated by the system 100 and/or retrieved from one or more information sources. In at least on embodiment of the present disclosure, database 140 can be “associated with” server 130 where, as shown in the embodiment in FIG. 1, database 140 resides on server 130. Database 140 can also be “associated with” server 130 where database 140 resides on a server or computing device remote from server 130, provided that the remote server or computing device is capable of bi-directional data transfer with server 130, such as, for example, in Amazon AWS, Rackspace, or other virtual infrastructure, or any business network. In at least one embodiment of the present disclosure, the remote server or computing device upon which database 140 resides is electronically connected to server 130 such that the remote server or computing device is capable of continuous bi-directional data transfer with server 130.

For purposes of clarity, database 140 is shown in FIG. 1, and referred to herein as a single database. It will be appreciated by those of ordinary skill in the art that database 140 may comprise a plurality of databases connected by software systems of a type well known in the art, which collectively are operable to perform the functions delegated to database 140 according to the present disclosure. Database 140 may also be part of distributed data architecture, such as, for example, a Hadoop architecture, for big data services. Database 140 may comprise relational database architecture, noSQL, OLAP, or other database architecture of a type known in the database art. Database 140 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Database 140 retrievably stores information that is communicated to database 140 from client device 110 or server 130.

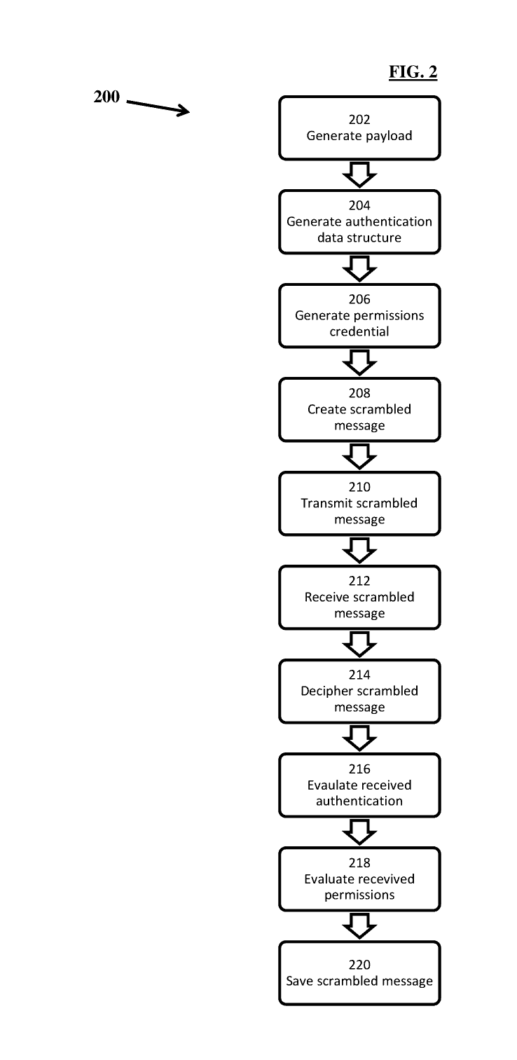

FIG. 2 illustrates a method to secure file origination, access and updates between a sender and a receiver, generally indicated at 200. The method 200 includes step 202 of generating a transmit payload, step 204 of generating an authentication data structure, step 206 of generating a permissions credential, step 208 of creating a scrambled message, step 210 of transmitting the scrambled message, step 212 of receiving the scrambled message, step 214 of deciphering the scrambled message, step 216 evaluating the received authentication, and step 218 of evaluating the received permissions.

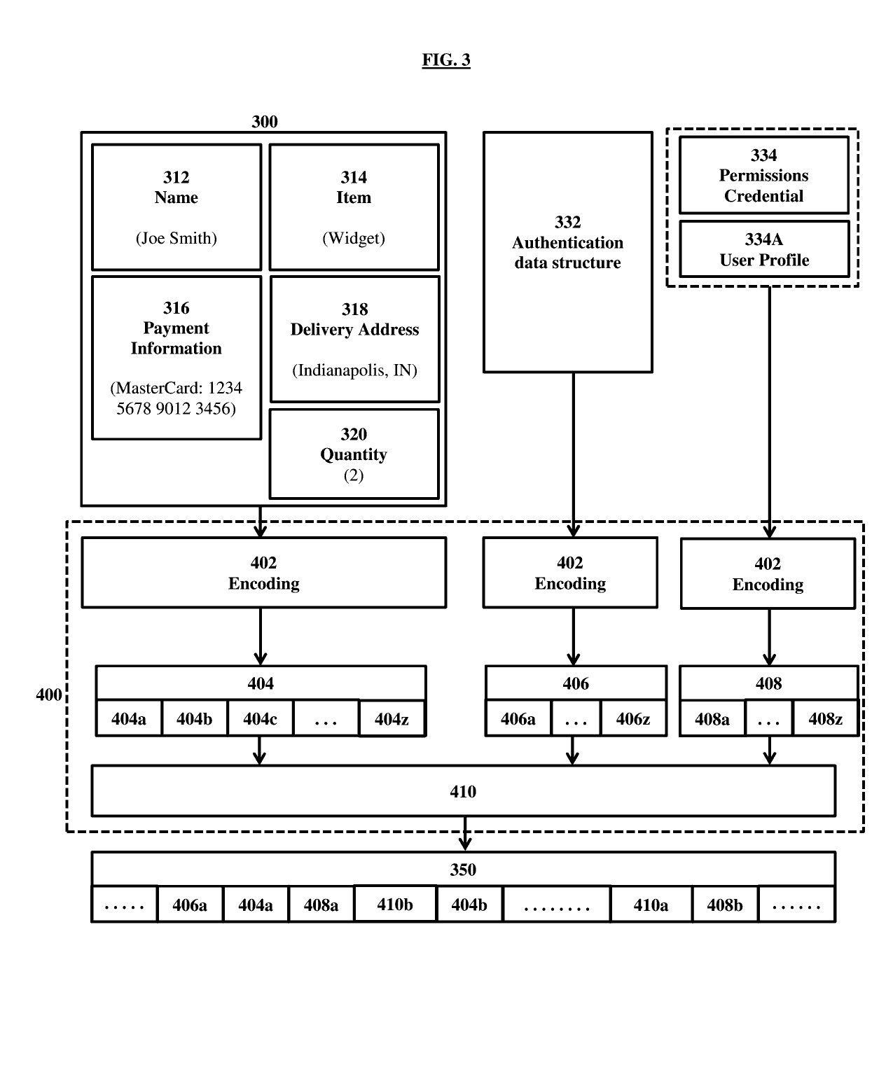

In at least one embodiment of the present invention, step 202 includes generating a transmit payload 300. For example, FIG. 3 shows one embodiment of a commonplace online shopping transaction scenario to generate a transmit payload 300. A purchaser (not shown) operates a device (e.g. client device 110) to access a merchant's website (not shown) that resides on a web server (e.g. server 130). Upon access to the merchant's website, the purchaser attempts to make a purchase via a transaction generally referred to as an “order.” The purchaser's device will be operated to generate a transmit payload 300 of order information to the merchant's website. The transmit payload 300 may comprise information about the order, such as the name 312 of the purchaser, the item 314 being purchased, the payment information 316, the delivery address 318, and the quantity 320 of the item, to name a few non-limiting examples.

The method 200 further includes step 204 of generating an authentication data structure 332. In at least one embodiment of the present invention, the authentication data structure 332 includes authentication information such as, for example, user identification, passwords, fingerprints, iris scanning data, retinal recognition data, voice prints, facial biometric data, geolocation data, token keys, user context data, user device information, and software instance signatures. For example, a user may use authentication device 120 to scan his/her fingerprints, record a voice sample by speaking a statement, and provide her/her geolocation information in order to generate authentication data structure 332. It will be appreciated that a plurality of authentication information may be used in conjunction.

The method 200 further includes step 206 generating a permissions credential 334 to transmit to the receiver. In at least one embodiment of the present invention, the permissions credential includes a user profile 334A. The user profile 334A may contain user preferences, user's permissions, access controls, location, and any other type of information associated with the user and his/her user identification. In at least one embodiment of the present invention, the user profile 334A may be stored on database 140.

The method 200 further includes step 208 of creating a scrambled message 350, by applying a pre-determined scheme 400. Referring to FIG. 3 for example, it is shown one embodiment of the application of a pre-determined scheme 400, to interleave parts of the transmit payload 300, the authentication data structure 332, and the permissions credential 334, to produce the scrambled message 350. The scrambled message 350 is obfuscated so that it cannot be deciphered into a human readable version. Since parts of the transmit payload 300, the authentication data structure 332, and the permissions credential 334 are interleaved, each part of the obfuscated scrambled message 350 is logically cohesive.

Referring to FIG. 3, in operation 402, the transmit payload 300, the authentication data structure 332, and the permissions credential 334 are transformed into bit streams 404, 406, and 408, using BASE64 encoding, to name one non-limiting example. It will be appreciated that methods used in pre-determined scheme 400 may include, such as, for example, salting, obfuscation, encryption, transmutation, data embedding, encoding, encrypting utilizing a one-time pad key, software based data obfuscation, data masking, or public key encryption, to name a few non-limiting examples. To further obfuscate the bit streams 404, 406, and 408, they are segregated into parts (e.g. 404a, 404b, 406a, 408a). Operation 410 interleaves the segregated parts to create scrambled message 350. For example, bit stream 404a, derived from the transmit payload 300, is inserted between bit stream 406a (derived from the authentication data structure 332), and bit stream 408a (derived from the permissions credential 334). As a result, the scrambled message 350 is a logical combination of the plurality of bit streams 404, 406, and 408 that is transmitted to sender.

In one embodiment of the present invention, operation 410 may also interleave randomly generated bit streams (e.g. 410a, 410b). It will be appreciated that by interleaving, obscuring, and breaking apart the transmit payload 300, authentication data structure 332, and permissions credential 334, the entropy of the parts is increased thereby making scrambled message 350 incapable of being deciphered (i.e. hackers for example, will find it difficult to eavesdrop or decipher scrambled message 350 without knowledge of the pre-determined scheme).

It will also be appreciated that the pre-determined scheme 400 operates to combine the payload (e.g. transmit payload 300), authentication information (e.g. authentication data structure 332), and permissions (e.g. permissions credential 334), to create a unitary, logical volume of data that is transmitted (e.g. scrambled message 350). By combining the payload, authentication information, and permissions, the transmitted data is of a type that promotes security by the absence, or at least the lack of decipherability of critical and important information within the transmitted data. For example, the payload and authentication information is embedded within the transmitted data that is complex and of high entropy such that the transmitted data is incapable of being deciphered, therefore protecting the principles of security, and integrity of the transmitted data.

The method 200 further includes steps 210 and 212 of transmitting and receiving the scrambled message 350. The scrambled message 350 may be transmitted from a sender by any means readily understood by one skilled in the art, such as for example, the internet. The scrambled message 350 may be received by any receiver, capable of receiving scrambled message 350.

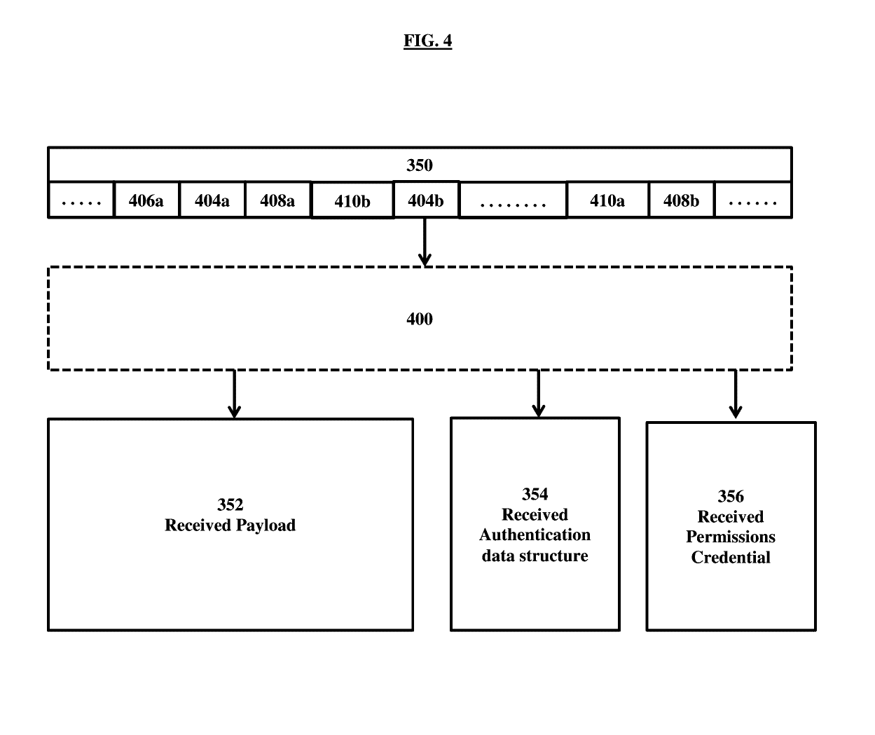

The method 200 further includes step 214 of deciphering the scrambled message. Referring to FIG. 4, it is shown a method for applying the pre-determined scheme 400, according to at least one embodiment of the present invention. The pre-determined scheme 400 is applied to the scrambled message 350 to recover received payload 352, received authentication data structure 354, and received permissions credential 356. In at least one embodiment of the present invention, the pre-determined scheme 400 used to generate the scrambled message 350 in step 208 is reversed, to recover the received payload 352, the received authentication data structure 354, and the received permissions credential 356. For example, if step 208 used a BASE64 encoding operation followed by encryption using a one-time pad, as the pre-determined scheme 400, the reverse operation is performed on the scrambled message 350 (i.e. decryption using a one-time pad is performed on scrambled message 350, followed by a BASE64 decoding) to recover the received payload 352, the received authentication data structure 354, and the received permissions credential 356.

The method 200 further includes step 216 of evaluating the received authentication data structure 354. In at least one embodiment of the present invention, the step 216 includes different checks depending on the type of received authentication data structure 354. For example, if the sender's fingerprint is recovered from the received authentication data structure 354, the sender's fingerprint is evaluated to ensure that the fingerprint matches the user identification. If the received authentication data structure 354 includes the sender's geolocation, the sender's geolocation is evaluated to ensure that the source of the scrambled message 350 is appropriate. For example, referring to the online shopping transaction scenario, if a purchaser is known to reside in the United States, the geolocation should reflect this. If however, the received authentication data structure 354 shows that the geolocation is outside of the United States, then the evaluation fails and the system 100 ignores the received payload 352. At step 216, if the evaluation succeeds, the system 100 continues to step 218. It will be appreciated that step 216 of evaluating the received authentication data structure 354 may be performed by any means available to an individual having ordinary skill in the arts.

The method 200 further comprises step 218 of evaluating the received permissions credential 356. In at least one embodiment of the present invention, the received permissions credential 356 is evaluated on a workflow basis. The system 100 may require the performance of at least one task within a workflow, with the at least one task necessary to move forward within the workflow, and storing information associated with the user performing the task, and comparing stored information with a stored user profile, to determine whether authentication of the user is successful or unsuccessful based on the comparison. It will be appreciated that the system 100 performs sequences of workflow events to verify that the sender is trusted, and the authentication process may be less rigorous (e.g., a password is sufficient) for that sender. However, certain sequences of workflow events may indicate that the sender is less trusted, and the receiver may require additional authentication required from that sender (e.g. a password and a fingerprint scan) in order to process the received payload 352. Referring to the online shopping scenario for example, the merchant receiver may verify if purchaser is authorized to purchase item 314, or if purchaser is authorized to purchase item 314 in the quantities requested. For example, if the received payload 352 shows that purchaser has placed an order for 300 widgets, but the received permissions credential 356 shows that the purchaser is only authorized to make a maximum purchase of 200 widgets, the merchant receiver will consider the transaction as illegitimate, and therefore cancel it. However, if received permissions credential 356 is verified and deemed to be a legitimate transaction, the merchant receiver will then process the transaction.

The method 200 also includes step 220 of processing the transaction. In at least one embodiment of the present invention, the system 100 may allow for the processing of the received payload 352, by any means available to a person having ordinary skill in the arts. For example, the received payload 352 may be stored in a database, to name one non-limiting example. In another embodiment of the present invention, the scrambled message 350 is stored in its entirety on a database. It will be appreciated that by storing scrambled message 350, an unauthorized user even with access to the database will still be unable to decipher scrambled message 350 to retrieve the received payload 352, the received authentication data structure 354, and the received permissions credential 356.

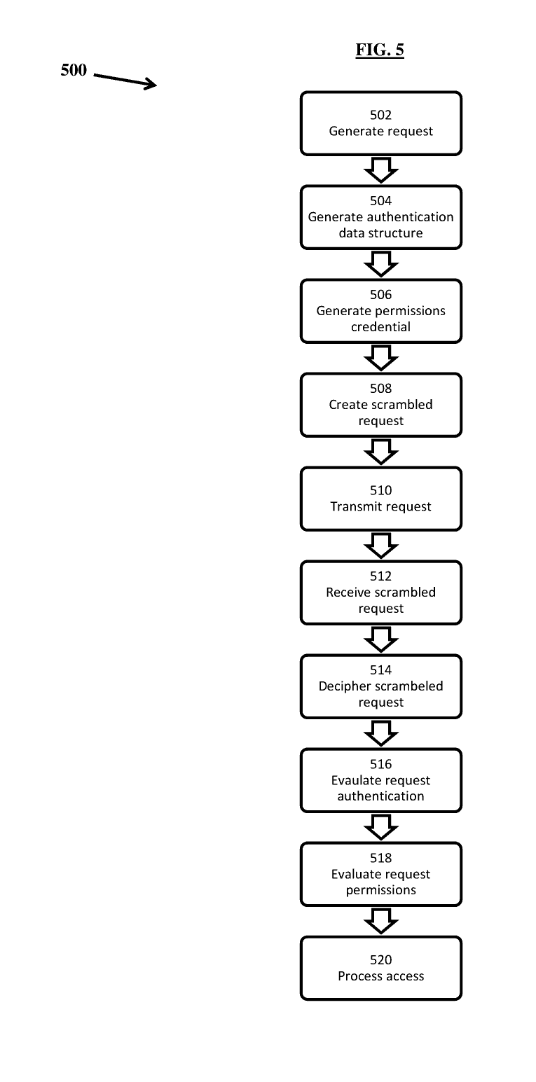

FIG. 5 illustrates a method to secure file origination, access and updates between a sender and a receiver, according to another embodiment of the present invention, generally indicated at 500. The method 500 includes step 502 of generating a request for file access, step 504 of generating an authentication data structure, step 506 of generating a permissions credential, step 508 of creating a scrambled request, step 510 of transmitting the scrambled request, step 512 of receiving the scrambled request, step 514 of deciphering the scrambled request, step 516 of evaluating request authentication, step 518 of evaluating request permissions, and step 520 of processing access.

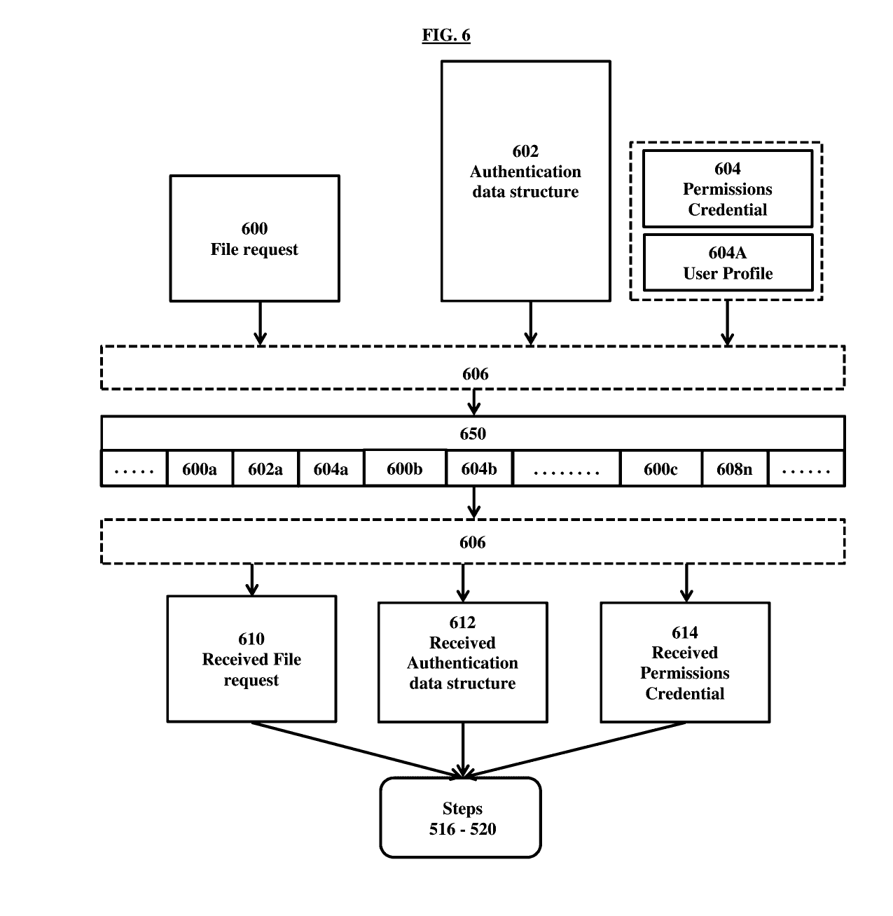

In at least one embodiment of the present invention, step 502 includes generating a request to access a file. For example, referring to FIG. 6, a user may operate a device (e.g. client device 110) to access a file stored on a server (e.g. database 140). The user's device will be operated to transmit a file request 600. The file request 600 may comprise information about the file, such as the name 502, to name one non-limiting example.

The method 500 further includes step 504 of generating an authentication data structure 602. In at least one embodiment of the present invention, the authentication data structure 602 includes authentication information such as, for example, user identification, passwords, fingerprints, iris scanning data, retinal recognition data, voice prints, facial biometric data, geolocation data, token keys, user context data, user device information, and software instance signatures. For example, a user may use authentication device 120 to scan his/her fingerprints, record a voice sample by speaking a statement, and provide her/her geolocation information in order to generate authentication data structure 602. It will be appreciated that a plurality of authentication information may be used in conjunction.

The method 500 further includes step 506 generating a permissions credential 604 to transmit to the receiver. In at least one embodiment of the present invention, the permissions credential includes a user profile 604A. The user profile 604A may contain user preferences, user's permissions, access controls, location, and any other type of information associated with the user and his/her user identification, to name a few non-limiting examples. In at least one embodiment of the present invention, the user profile 604A may be stored on database 140.

The method 500 further includes step 508 of creating a scrambled request 650, by applying a pre-determined scheme 606. Referring to FIG. 6 for example, it is shown one embodiment of the application of pre-determined scheme 606 used to interleave parts of the file request 600, the authentication data structure 602, and the permissions credential 604, to produce the scrambled request 650. The scrambled request 650 is obfuscated so that it cannot be deciphered into a human readable version. Since parts of the file request 600, the authentication data structure 602, and the permissions credential 604 are interleaved, each part of the obfuscated scrambled request 650 is logically cohesive.

It will be appreciated that methods used in pre-determined scheme 600 may include, such as, for example, salting, obfuscation, encryption, transmutation, data embedding, encoding, encrypting utilizing a one-time pad key, software based data obfuscation, data masking, or public key encryption, to name a few non-limiting examples. It will be appreciated that the pre-determined scheme 600 will be such that a reverse transformation method can be applied to the scrambled request 606 to retrieve the file request 600, authentication data structure 602, and permissions credential 604, before transformation.

The method 500 further includes step 510 of transmitting and receiving the scrambled request 650. The scrambled request 650 may be transmitted from a sender by any means readily understood by one skilled in the art, such as for example, the internet. The scrambled request 650 may be received by any receiver, capable of receiving scrambled request 650.

The method 400 further includes step 514 of deciphering the scrambled message. The pre-determined scheme 606 is applied to the scrambled request 650 to recover received file request 610, received authentication data structure 612, and the received permissions credential 614. In at least one embodiment of the present invention, the pre-determined scheme 606 used to generate the scrambled request 650 in step 508 is reversed, to recover the received file request 610, the received authentication data structure 612, and the received permissions credential 614. For example, if step 508 used a BASE64 encoding operation followed by encryption using a one-time pad, as the pre-determined scheme 606, the reverse operation is performed on the scrambled request 650 (i.e. decryption using a one-time pad is performed on scrambled request 650, followed by a BASE64 decoding) to recover the received file request 610, the received authentication data structure 612, and the received permissions credential 614.

The method 500 further includes step 516 of evaluating the received authentication data structure 612. In at least one embodiment of the present invention, the step 516 includes different checks depending on the type of received authentication data structure 354. For example, if the sender's fingerprint is recovered from the received authentication data structure 612, the sender's fingerprint is evaluated to ensure that the fingerprint matches the user identification. If the received authentication data structure 612 includes the sender's geolocation, the sender's geolocation is evaluated to ensure that the source of the scrambled request 650 is appropriate. For example, if a user is known to reside in the United States, the geolocation should reflect this. If however, the received authentication data structure 612 shows that the geolocation is outside of the United States, then the evaluation fails and the system 100 ignores the received file request 610. At step 516, if the evaluation succeeds, the system 100 continues to step 518. It will be appreciated that step 516 of evaluating the received authentication data structure 612 may be performed by any means available to an individual having ordinary skill in the arts.

The method 500 further comprises step 518 of evaluating the received permissions credential 614. In at least one embodiment of the present invention, the received permissions credential 614 is evaluated on a workflow basis. The system 100 may require the performance of at least one task within a workflow, with the at least one task necessary to move forward within the workflow, and storing information associated with the user performing the task, and comparing stored information with a stored user profile, to determine whether authentication of the user is successful or unsuccessful based on the comparison. It will be appreciated that the system 100 performs sequences of workflow events to verify that the sender is trusted, and the authentication process may be less rigorous (e.g., a password is sufficient) for that sender. However, certain sequences of workflow events may indicate that the sender is less trusted, and the receiver may require the amount of authentication required from that sender (e.g. a password and a fingerprint scan) in order to process the received file request 610. For example, a use may request access to a file with the ability to modify its contents. If the received permissions credential 614 shows that the use is only authorized read the file and not modify its contents, the receiver will consider the received file request 610 as illegitimate, and therefore ignore it. However, if received permissions credential 614 is verified and deemed to be legitimate, the receiver will then process the received file request 610, at step 520.

The method 500 also includes step 520 of processing the received file request 610. In at least one embodiment of the present invention, the system 100 may allow for the processing of the received file request 610, by any means available to a person having ordinary skill in the arts. For example, if the received file request 610 seeks read and write access to a file, the system 100 will grant such access to the user.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method to secure file origination, access and updates between a sender and a receiver, the method comprising the steps of:
a. generating a payload;
b. generating an authentication data structure;
c. generating a permissions credential;
d. creating a scrambled message bit stream by combining and transforming the payload, the authentication data structure, and the permissions credential, using a pre-determined scheme;
e. transmitting the scrambled message bit stream to the receiver;
f. receiving the scrambled message bit stream;
g. applying the pre-determined scheme to recover a received payload, a received authentication data structure, and a received permissions credential, from the scrambled message bit stream;
h. evaluating the received authentication data structure, and if authentication fails, ignoring the received payload;
i. evaluating the received permissions credential, and if the received permissions credentials are sufficient, proceeding to step (j.);
j. processing the scrambled message bit stream;
k. performing steps (a.)-(j.) for subsequent communications between the sender and the receiver.

2. The method of claim 1, wherein the authentication data structure is authentication information selected from a group consisting of biometrics, geolocation, user information, and the sender's device information.

3. The method of claim 1, wherein the permissions credential comprises user access controls.

4. The method of claim 1, wherein the pre-determined scheme is selected from a group comprising of salting, obfuscation, symmetric key encryption, transmutation, data embedding, encoding, one-time pad key encryption, software based data obfuscation, data masking, and public key encryption.

5. The method of claim 1, wherein the pre-determined scheme of step (d.) further comprises transforming the payload into a payload bit stream, the authentication data structure into an authentication bit stream, and the permissions credential into a permissions bit stream, and interleaving the payload bit stream, the authentication bit stream, and the permission bit stream, to create the scrambled message bit stream.

6. The method of claim 1, wherein step (i.) further comprises ignoring the received payload if the received permissions credentials are insufficient.

7. The method of claim 1, wherein step (i.) further comprises requesting additional authentication information if the received permissions credentials are insufficient.

8. The method of claim 1, wherein step (j.) further comprises storing the scrambled message bit stream.
